(19) United States
(12) Patent Application Publication
(10) Pub. No.: US 2025/0031193 A1
(43) Pub. Date: Jan. 23, 2025

(54) FREQUENCY DOMAIN RESOURCE CONFIGURATION METHOD AND APPARATUS, AND FREQUENCY DOMAIN RESOURCE SWITCHING METHOD AND APPARATUS

(71) Applicant: BEIJING UNISOC COMMUNICATIONS TECHNOLOGY CO., LTD., Beijing (CN)

(72) Inventor: Miao WANG, Shanghai (CN)

(21) Appl. No.: 18/686,548

(22) PCT Filed: Aug. 9, 2022
(86) PCT No.: PCT/CN2022/111057

§ 371 Date: Feb. 26, 2024

(30) Foreign Application Priority Data
Aug. 25, 2021 (CN) 202110984206.2

(51) Int. Cl. H04W 72/0453; H04L 5/00

(52) U.S. Cl. CPC H04W 72/0453; H04L 5/0092

(57) ABSTRACT

A frequency domain resource configuration method and apparatus, and a frequency domain resource switching method and apparatus are provided. The frequency domain resource configuration method includes: generating frequency domain resource set configuration information, where the frequency domain resource set configuration information indicates one or more first frequency domain resources and a channel bandwidth where each of the one or more first frequency domain resources is located; and transmitting the frequency domain resource set configuration information to a terminal device.

### CROSS-REFERENCE TO RELATED APPLICATIONS

This is the U.S. national stage of application No. PCT/CN2022/111057 filed on Aug. 9, 2022. Priority under 35 U.S.C. § 119 (a) and 35 U.S.C. § 365 (b) is claimed from Chinese Patent Application No. 202110984206.2, filed on Aug. 25, 2021, the disclosure of which is also incorporated herein.

### TECHNICAL FIELD

The present disclosure generally relates to communication technology field, and more particularly, to a frequency domain resource configuration method and apparatus, a frequency domain resource switching method and apparatus, a network device and a terminal device.

### BACKGROUND

Due to diversification of services, especially considering business needs of vertical industries, different services have different uplink and downlink transmission requirements. In a Time Division Duplexing (TDD) system, single uplink and downlink configuration cannot meet needs of different services. Therefore, a subband full-duplex solution has been proposed, that is, different subbands of a same carrier use different uplink and downlink configurations.

### SUMMARY

An embodiment of the present disclosure provides a frequency domain resource switching method and apparatus, and a terminal device, thereby realizing a flexible switch between different frequency domain resources and reducing an out-of-band spectrum leakage.

In an embodiment of the present disclosure, a frequency domain resource switching method is provided, performed by a terminal device and including: receiving frequency domain resource set configuration information, where the frequency domain resource set configuration information includes a first frequency domain resource; determining a channel bandwidth where the first frequency domain resource is located based on the frequency domain resource set configuration information; and switching to the first frequency domain resource and the channel bandwidth where the first frequency domain resource is located.

In an embodiment of the present disclosure, a non-volatile or non-transitory computer-readable storage medium having computer instructions stored therein is provided, where when the computer instructions are executed by a processor, the above method is performed.

### BRIEF DESCRIPTION OF THE DRAWINGS

FIG. 1 is a diagram of a subband full-duplex mode in existing techniques.

FIG. 2 is a flow chart of a frequency domain resource configuration method according to an embodiment.

FIG. 3 is a flow chart of a frequency domain resource switching method according to an embodiment.

FIG. 4 is a flow chart of a frequency domain resource configuration and switching procedure according to an embodiment.

FIG. 5 is a flow chart of a frequency domain resource configuration and switching procedure according to an embodiment.

FIG. 6 is a flow chart of a frequency domain resource configuration and switching procedure according to an embodiment.

FIG. 7 is a block diagram of a frequency domain resource configuration apparatus according to an embodiment.

FIG. 8 is a block diagram of a frequency domain resource configuration apparatus according to an embodiment.

FIG. 9 is a block diagram of a frequency domain resource switching apparatus according to an embodiment.

### DETAILED DESCRIPTION

In order to clarify the objects, characteristics and advantages of the disclosure, embodiments of present disclosure will be described in detail in conjunction with accompanying drawings.

According to requirements of the 3rd Generation Partnership Project (3GPP), a channel bandwidth configured by a next generation Node B (gNB) for a terminal device determines a minimum radio frequency indicator that the terminal device needs to meet, and a BandWidth Part (BWP) of the terminal device should be within a Channel Band Width (CBW).

A current standard specifies that different uplink BWPs can be configured for a terminal device. A configuration granularity of BWP is RB level, that is, BWP may include several Resource Blocks (RB). BWP is a form of subband. If a radio frequency indicator of the terminal device is required to correspond to the subband, it is required that when a bandwidth of the subband is any RB (less than or equal to a maximum number of RBs of the bandwidth), the terminal device must meet the corresponding radio frequency indicator requirement. In the current standard, the terminal device reports a supported CBW with a value range of [5, 10, 15, 20, 25, 30, 40, 50, 60, 80, 100] under FR1 (frequency range 1) and [50, 100, 200] under FR2 (frequency range 2) and a unit of MHz. If a radio frequency indicator of the terminal device is required to correspond to the subband, the terminal device needs to support other CBWs besides existing values, which is difficult in implementation for the terminal device. If the value of the subband is limited to [5, 10, 15, 20, 25, 30, 40, 50, 60, 80, under FR1 and [50, 100, 200] under FR2, flexibility in resource scheduling is limited. The subband refers to a continuous frequency domain resource within the channel bandwidth.

In the subband full-duplex mode, taking FIG. 1 as an example, if an uplink frequency domain resource of the terminal device is a middle UpLink (UL) subband, radio frequency indicator requirements of the device terminal when the gNB configures different CBWs for the terminal device are compared. Assume follows:

Configuration 1: the gNB configures a smaller CBW1 for the terminal device, for example, its bandwidth is the same as the UL subband;

Configuration 2: the gNB configures a larger CBW2 for the terminal device, for example, the UL subband, the UL and DownLink (DL) subbands are all within the CBW.

When the terminal device works in the UL subband, an out-of-band spectrum leakage requirement of the terminal device in configuration 1 is stricter than that in configuration 2. Therefore, in configuration 1, the uplink of the terminal device has less interference on the adjacent DL subband or UL&DL subband than that in configuration 2. However, in configuration 1, the terminal device can only be scheduled in the UL subband, while in configuration 2, the terminal device can switch from the UL subband to the UL&DL subband. From above, the existing frequency domain resource configuration method cannot realize a small out-of-band spectrum leakage of the terminal device and a flexible switch between different subbands simultaneously.

Embodiments of the present disclosure provide a frequency domain resource configuration method and apparatus, and a frequency domain resource switching method and apparatus, which reduces an out-of-band spectrum leakage of a terminal device, and also enables a flexible switch between different frequency domain resources. Specifically, when the network device configures frequency domain resources for the terminal device, it also configures the channel bandwidth for each frequency domain resource, generates frequency domain resource set configuration information, and delivers the frequency domain resource set configuration information to the terminal device. Accordingly, the terminal device receives the frequency domain resource set configuration information, determines the channel bandwidth where the first frequency domain resource to be switched is located based on the frequency domain resource set configuration information, and switches to the first frequency domain resource and the channel bandwidth where the first frequency domain resource is located.

It should be noted that the first frequency domain resource mentioned in the embodiments of the present disclosure refers to a continuous frequency domain resource within the channel bandwidth, which may include several RBs. In specific applications, it may be the aforementioned BWP or subband, that is, both subband and BWP are the first frequency domain resource.

In addition, it should be noted that the network device can configure one or more of the above-mentioned first frequency domain resources and their channel bandwidths for the terminal device, so that the terminal device can flexibly switch between different frequency domain resources in different application scenarios, to better meet requirements on the frequency domain resources and the channel bandwidths in different application scenarios. In the embodiments of the present disclosure, the network device may be a base station or a gNB.

Solutions of the present disclosure are described in detail from the network device side and the terminal device side respectively below.

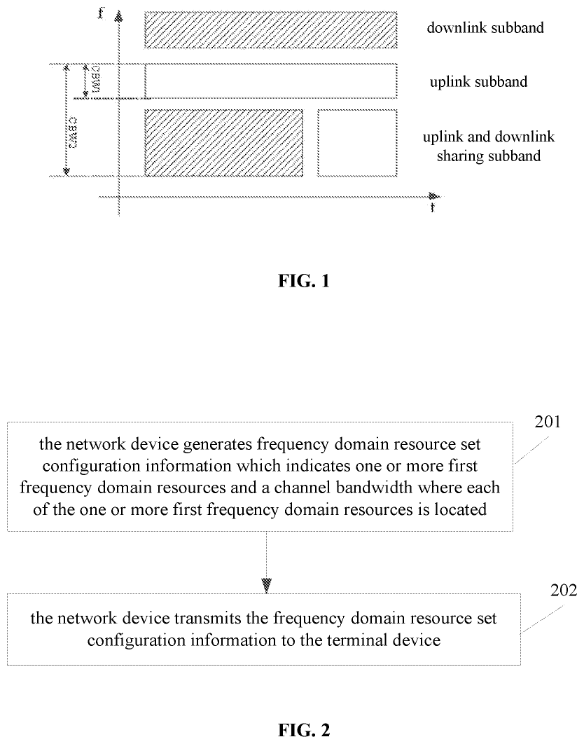

Referring to FIG. 2. FIG. 2 is a flow chart of a frequency domain resource configuration method according to an embodiment. This embodiment illustrates a process of configuring frequency domain resources for a terminal device from a network device side. The process shown in FIG. 2 includes following steps.

In 201, the network device generates frequency domain resource set configuration information which indicates one or more first frequency domain resources and a channel bandwidth where each of the one or more first frequency domain resources is located.

In some embodiments, the frequency domain resource set configuration information may be generated in various ways, which is described in detail below.

In 202, the network device transmits the frequency domain resource set configuration information to the terminal device.

In some embodiments, the frequency domain resource set configuration information may be transmitted to the terminal device through a Radio Resource Control (RRC) message, that is, the RRC message carrying the frequency domain resource set configuration information is transmitted to the terminal device.

It should be noted that the above channel bandwidth may be determined based on capability information of the terminal device. Accordingly, in some embodiments, following steps may also be included: receiving capability information reported by the terminal device; and determining the channel bandwidth based on the capability information.

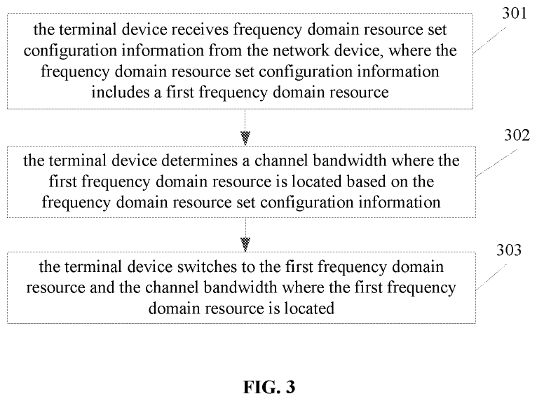

Referring to FIG. 3, FIG. 3 is a flow chart of a frequency domain resource switching method according to an embodiment. This embodiment illustrates a frequency domain resource switching process of a terminal device based on a frequency domain resource set configured by a network device. The process shown in FIG. 3 includes following steps.

In 301, the terminal device receives frequency domain resource set configuration information from the network device, where the frequency domain resource set configuration information includes a first frequency domain resource.

In 302, the terminal device determines a channel bandwidth where the first frequency domain resource is located based on the frequency domain resource set configuration information.

As mentioned above, there are various ways for the network device to generate the frequency domain resource set configuration information. Accordingly, specific contents and structural forms of the frequency domain resource set configuration information are also different. Accordingly, the channel bandwidth where the first frequency domain resource is located also adaptively changes based on the specific contents and structural forms of the frequency domain resource set configuration information, which is described in detail below.

In 303, the terminal device switches to the first frequency domain resource and the channel bandwidth where the first frequency domain resource is located.

Frequency domain resource switching by the terminal device is scheduled by the network device through RRC, Media Access Control Address (MAC) Control Element (CE) or Downlink Control Information (DCI) which indicates the frequency domain resource that the terminal device switches to, and the terminal device switches based on instructions of the network device.

As each frequency domain resource is configured with its own channel bandwidth, the terminal device can flexibly switch between different frequency domain resources, the channel bandwidth in which the terminal device works also changes accordingly, and an out-of-band spectrum leakage is reduced.

In specific implementation, the network device may use various methods to generate and transmits the frequency domain resource set configuration information to the terminal device. Accordingly, ways for the terminal device to determine the channel bandwidth where the first frequency domain resource is located are different based on different forms of the frequency domain resource set configuration information, which is explained below with examples.

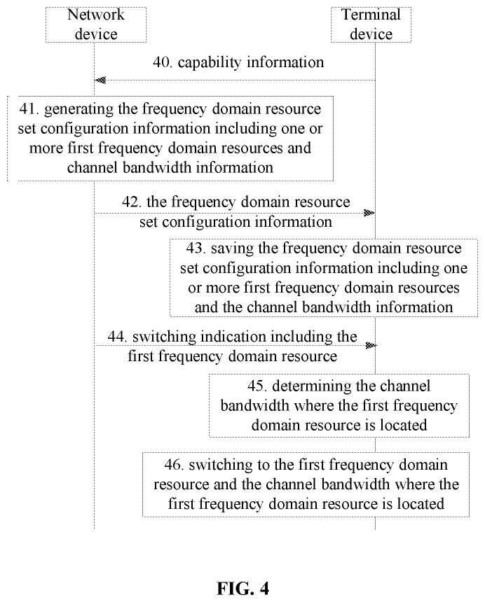

In an embodiment, referring to FIG. 4, a specific procedure is as follows.

First, in 40, the terminal device reports capability information to the network device, where the reported capability information includes the channel bandwidth supported by the terminal device.

Accordingly, in 41, the network device generates the frequency domain resource set configuration information for the terminal device based on the capability information reported by the terminal device. The frequency domain resource set configuration information includes one or more first frequency domain resources and the channel bandwidths where the one or more frequency domain resources are located. Specifically, the network device determines one or more first frequency domain resources to be configured and channel bandwidth information of each first frequency domain resource, where the channel bandwidth information includes a center frequency point and a bandwidth; and then generates the frequency domain resource set configuration information.

It should be noted that the network device may explicitly configure the center frequency point of the channel bandwidth and the number of PRBs included, or may implicitly configure the center frequency point and the bandwidth of the channel bandwidth by configuring a starting PRB and an ending PRB of the channel bandwidth, or implicitly configure the center frequency point and the bandwidth of the channel bandwidth by configuring the start PRB and the ending PRB of the channel bandwidth and the number of PRBs included.

Afterward, in 42, the network device transmits the above frequency domain resource set configuration information to the terminal device.

Accordingly, in 43, after receiving the above frequency domain resource set configuration information, the terminal device saves the frequency domain resource set configuration information.

In 44, the network device discovers that the terminal device needs to perform frequency domain resource switching in a current scenario, and thus transmits switching indication to the terminal device, for example, instructing the terminal device to perform frequency domain resource switching through RRC, MAC CE or DCI, and indicating to the terminal device the first frequency domain resource that the terminal device needs to switch to.

Accordingly, in 45, after receiving the switching indication from the network device, the terminal device searches among the saved frequency domain resource configuration information and determines the channel bandwidth where the first frequency domain resource is located.

Afterward, in 46, the terminal device switches to the first frequency domain resource and the channel bandwidth where the first frequency domain resource is located.

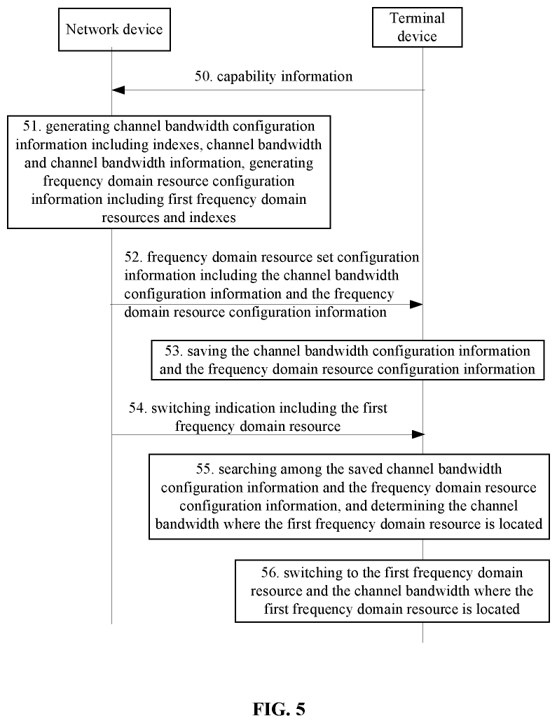

In an embodiment, referring to FIG. 5, a specific procedure is as follows.

First, in 50, the terminal device reports capability information to the network device. The reported capability information includes the channel bandwidth supported by the terminal device.

Accordingly, in 51, the network device generates channel bandwidth configuration information for the terminal device based on the capability information reported by the terminal device. The channel bandwidth configuration information includes at least two channel bandwidths, as well as an index of each channel bandwidth and channel bandwidth information. The above channel bandwidth information includes a center frequency point and bandwidth. A method of configuring the channel bandwidth by the network device may refer to the method in 41, which is not repeated here. In addition, the network device further determines the one or more first frequency domain resources to be configured and the channel bandwidth where each first frequency domain resource is located and generates frequency domain resource configuration information which includes the one or more first frequency domain resources and an index of the channel bandwidth where each first frequency domain resource is located.

In 52 to 54, more details of the network device and the terminal device can be referred to 42 to 44 and are not repeated here.

In 55, after receiving the switching indication from the network device, the terminal device first searches among the saved frequency domain resource configuration information and determines the index of the channel bandwidth where the first frequency domain resource is located. Afterward, the saved channel bandwidth configuration information is searched to determine the channel bandwidth corresponding to the index, thereby determining the channel bandwidth where the first frequency domain resource is located.

Afterward, in 56, the terminal device switches to the first frequency domain resource and the channel bandwidth where the first frequency domain resource is located.

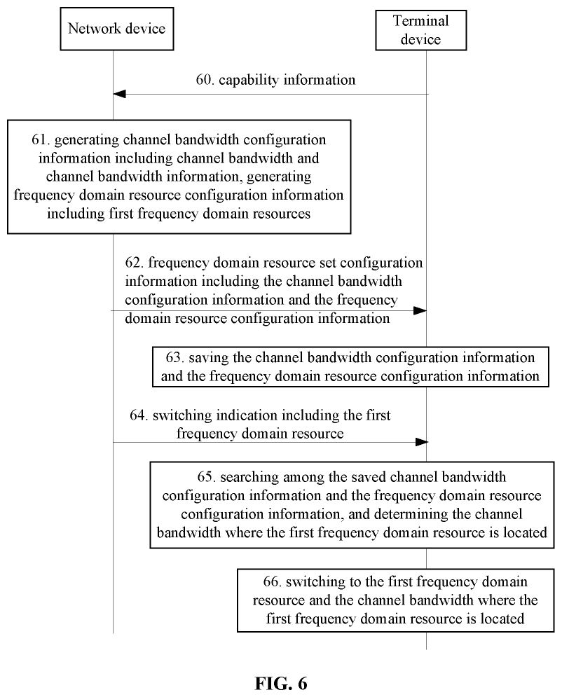

In an embodiment, referring to FIG. 6, a specific procedure is as follows.

First, in 60, the terminal device reports capability information to the network device. The reported capability information includes the channel bandwidth supported by the terminal device.

Accordingly, in 61, the network device generates channel bandwidth configuration information for the terminal device based on the capability information reported by the terminal device. The channel bandwidth configuration information includes at least two channel bandwidths and corresponding channel bandwidth information, where the channel bandwidth information includes a center frequency and bandwidth. A method of configuring the channel bandwidth by the network device may be referred to the method in 41 and is not repeated here. In addition, the network device further determines one or more first frequency domain resources to be configured and generates frequency domain resource configuration information which includes one or more first frequency domain resources.

It should be noted that, in the embodiment, the channel bandwidth of each first frequency domain resource is implicitly configured to include a smallest channel bandwidth of the first frequency domain resource. For example, according to standards, a smallest channel bandwidth including the first frequency domain resource among all default configured channel bandwidths is the channel bandwidth where the first frequency domain resource is located. When there are more than or equal to 2 smallest channel bandwidths with the same bandwidth, the channel bandwidth where the first frequency domain resource is located has the largest or smallest starting PRB among the smallest channel bandwidths. Whether it has the largest starting PRB or the smallest starting PRB is agreed by the standards or configured by the network device.

In 62 to 64, more details of the network device and the terminal device can be referred to 42 to 44 and are not repeated here.

In 65, after receiving the switching indication from the network device, the terminal device searches among the saved frequency domain resource configuration information, determines that the frequency domain resource configuration information includes the first frequency domain resource, determines all channel bandwidths including the first frequency domain resource based on the saved channel bandwidth configuration information, and selects a smallest channel bandwidth among all the channel bandwidths as the channel bandwidth where the first frequency domain resource is located. When there are more than or equal to 2 smallest channel bandwidths with the same bandwidth, the channel bandwidth where the first frequency domain resource is located has the largest/smallest starting PRB among the smallest channel bandwidths (as agreed by the standards or configured by the network device).

In 66, the terminal device switches to the first frequency domain resource and the channel bandwidth where the first frequency domain resource is located.

With the frequency domain resource configuration method, when the network device configures frequency domain resources for the terminal device, it also configures the channel bandwidth for each frequency domain resource, generates frequency domain resource set configuration information, and delivers the frequency domain resource set configuration information to the terminal device. Accordingly, with the frequency domain resource switching method, the terminal device receives the frequency domain resource set configuration information from the network device, determines the channel bandwidth where the first frequency domain resource to be switched is located based on the frequency domain resource set configuration information, and switches to the first frequency domain resource and the channel bandwidth where the first frequency domain resource is located. The above solutions enable the terminal device to flexibly switch between different frequency domain resources and ensure a small out-of-band spectrum leakage of the terminal device. Especially in a subband full-duplex mode, i.e., different frequency domain resources of a same carrier adopting different uplink and downlink configurations, interference between users may be reduced while using different uplink and downlink configurations for different services. Further, the solutions provide various indication methods for frequency domain resource set configuration information, which can be flexibly selected according to needs during specific implementation, thereby improving diversity and flexibility of solutions.

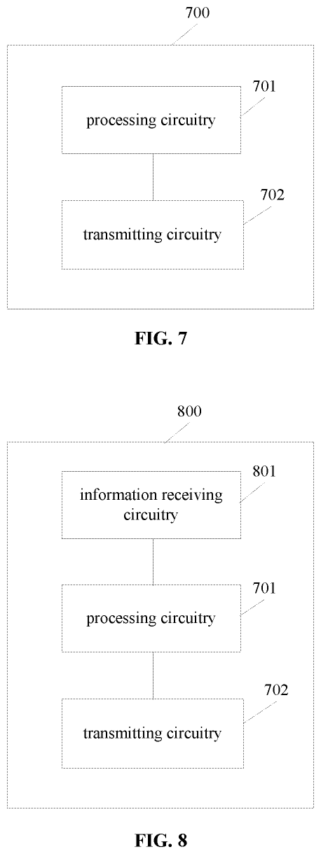

Accordingly, an embodiment of the present disclosure further provides a frequency domain resource configuration apparatus. Referring to FIG. 7, FIG. 7 is a block diagram of a frequency domain resource configuration apparatus according to an embodiment. The frequency domain resource configuration apparatus 700 includes: a processing circuitry 701 configured to generate frequency domain resource set configuration information, where the frequency domain resource set configuration information indicates one or more first frequency domain resources and a channel bandwidth where each of the one or more first frequency domain resources is located; and a transmitting circuitry 702 configured to transmit the frequency domain resource set configuration information to a terminal device.

There are various ways for the processing circuitry 701 to generate the frequency domain resource set configuration information. Accordingly, the frequency domain resource configuration set information may have various contents and forms as follows.

In some embodiments, the processing circuitry 701 includes: a frequency domain resource and channel bandwidth determining circuitry configured to determine one or more first frequency domain resources to be configured, and channel bandwidth information of each of the one or more first frequency domain resources, where the channel bandwidth information includes a center frequency point and a bandwidth; and a first information processing circuitry configured to generate the frequency domain resource set configuration information which includes the one or more first frequency domain resources and the channel bandwidth where each of the one or more first frequency domain resources is located.

In some embodiments, the processing circuitry 701 includes: a second information processing circuitry configured to generate channel bandwidth configuration information which includes at least two channel bandwidths, and an index and channel bandwidth information of each of the at least two channel bandwidths, where the channel bandwidth information includes a center frequency point and a bandwidth; a channel bandwidth determining circuitry configured to determine one or more first frequency domain resources to be configured and the channel bandwidth where each of the one or more first frequency domain resources is located; and a third information processing circuitry configured to generate frequency domain resource configuration information which includes the one or more first frequency domain resources and an index of the channel bandwidth where each of the one or more first frequency domain resources is located.

In the above embodiments, the frequency domain resource set configuration information includes the channel bandwidth configuration information and the frequency domain resource configuration information. Accordingly, the transmitting circuitry 702 is configured to transmit the channel bandwidth configuration information and the frequency domain resource configuration information to the terminal device.

In some embodiments, the processing circuitry 701 includes: a fourth information processing circuitry configured to generate channel bandwidth configuration information which includes at least two channel bandwidths and channel bandwidth information of each of the at least two channel bandwidths, where the channel bandwidth information includes a center frequency point and a bandwidth; a frequency domain resource determining circuitry configured to determine one or more frequency domain resources to be configured; and a fifth information processing circuitry configured to generate frequency domain resource configuration information which includes the one or more first frequency domain resources, where the channel bandwidth where each of the one or more first frequency domain resources is located is a smallest channel bandwidth including the first frequency domain resource that is contained in the channel bandwidth configuration information. When there are more than or equal to 2 smallest channel bandwidths with the same bandwidth, the channel bandwidth where the first frequency domain resource is located has the largest or smallest starting PRB among the smallest channel bandwidths. Whether it has the largest starting PRB or the smallest starting PRB is agreed by the standards or configured by the network device.

Similarly, in the above embodiments, the frequency domain resource set configuration information includes the channel bandwidth configuration information and the frequency domain resource configuration information. Accordingly, the transmitting circuitry 702 is configured to transmit the channel bandwidth configuration information and the frequency domain resource configuration information to the terminal device.

In some embodiments, the processing circuitry 701 may configure more than two channel bandwidths for the terminal device according to capability of the terminal device. Accordingly, referring to FIG. 8, a frequency domain resource configuration apparatus 800 according to another embodiment may include: an information receiving circuitry 801 configured to receive capability information reported by a terminal device; the processing circuitry 701 configured to generate frequency domain resource set configuration information based on the capability information reported by the terminal device, where the frequency domain resource set configuration information indicates one or more first frequency domain resources and a channel bandwidth where each of the one or more first frequency domain resources is located, the channel bandwidth being determined based on the capability information of the terminal device received by the information receiving circuitry 801; and the transmitting circuitry 702 configured to transmit the frequency domain resource set configuration information to the terminal device.

It should be noted that in the above embodiments of the frequency domain resource configuration apparatus, the transmitting circuitry 702 may carry the frequency domain resource set configuration information in an RRC message to transmit.

Accordingly, an embodiment of the present disclosure provides a network device which may include the frequency domain resource configuration apparatus of any of the above embodiments. The network device may be a base station, gNB and other apparatus.

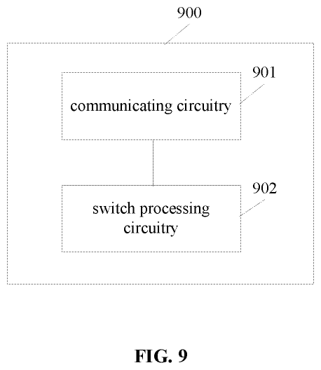

Accordingly, an embodiment of the present disclosure further provides a frequency domain resource switching apparatus. Referring to FIG. 9, FIG. 9 is a block diagram of a frequency domain resource switching apparatus according to an embodiment. The frequency domain resource switching apparatus 900 includes: a communicating circuitry 901 configured to receive frequency domain resource set configuration information, where the frequency domain resource set configuration information includes a first frequency domain resource; and a switch processing circuitry 902 configured to: determine a channel bandwidth where the first frequency domain resource is located based on the frequency domain resource set configuration information; and switch to the first frequency domain resource and the channel bandwidth where the first frequency domain resource is located.

The frequency domain resource configuration set information provided by the network device has various forms. Accordingly, the terminal device performs different processing based on the frequency domain resource configuration set information as follows.

In some embodiments, the frequency domain resource set configuration information includes one or more first frequency domain resources and channel bandwidth information of each of the one or more first frequency domain resources, and the channel bandwidth information includes a center frequency point and a bandwidth.

Accordingly, the switch processing circuitry 902 is configured to determine the channel bandwidth where the first frequency domain resource is located directly based on the frequency domain resource set configuration information.

In some embodiments, the frequency domain resource set configuration information includes frequency domain resource configuration information and channel bandwidth configuration information; the frequency domain resource configuration information includes one or more first frequency domain resources and an index of the channel bandwidth where each of the one or more first frequency domain resources is located; and the channel bandwidth configuration information includes at least two channel bandwidths, and an index and channel bandwidth information of each of the at least two channel bandwidths, where the channel bandwidth information includes a center frequency point and a bandwidth.

Accordingly, the switch processing circuitry 902 is configured to: determine the index of the channel bandwidth where the first frequency domain resource is located based on the frequency domain resource configuration information; and determine the channel bandwidth corresponding to the index based on the channel bandwidth configuration information.

In some embodiments, the frequency domain resource set configuration information includes frequency domain resource configuration information and channel bandwidth configuration information; the frequency domain resource configuration information includes one or more first frequency domain resources; and the channel bandwidth configuration information includes at least two channel bandwidths, and channel bandwidth information of each of the at least two channel bandwidths, where the channel bandwidth information includes a center frequency point and a bandwidth.

Accordingly, as a smallest channel bandwidth including the first frequency domain resource among default configured channel bandwidths is the channel bandwidth where the first frequency domain resource is located, in the embodiments, the switch processing circuitry 902 is configured to: determine the first frequency domain resource based on the frequency domain resource configuration information; determine channel bandwidths including the first frequency domain resource based on the channel bandwidth configuration information; and select a smallest channel bandwidth among the channel bandwidths as the channel bandwidth where the first frequency domain resource is located. When there are more than or equal to 2 smallest channel bandwidths with the same bandwidth, the channel bandwidth where the first frequency domain resource is located has the largest or smallest starting PRB among the smallest channel bandwidths. Whether it has the largest starting PRB or the smallest starting PRB is agreed by the standards or configured by the network device.

Accordingly, an embodiment of the present disclosure further provides a terminal device which may include the frequency domain resource switching apparatus of any of the above embodiments.

With the frequency domain resource configuration apparatus, when the network device configures frequency domain resources for the terminal device, it also configures the channel bandwidth for each frequency domain resource, generates frequency domain resource set configuration information, and delivers the frequency domain resource set configuration information to the terminal device. Accordingly, with the frequency domain resource switching apparatus, the terminal device receives the frequency domain resource set configuration information from the network device, determines the channel bandwidth where the first frequency domain resource to be switched is located based on the frequency domain resource set configuration information, and switches to the first frequency domain resource and the channel bandwidth where the first frequency domain resource is located. The above solutions enable the terminal device to flexibly switch between different frequency domain resources and ensure a small out-of-band spectrum leakage of the terminal device. Especially in a subband full-duplex mode, i.e . , different frequency domain resources of a same carrier adopting different uplink and downlink configurations, different requirements of different services for a slot ratio required for uplink and downlink transmission can be better met. Further, the solutions provide various indication methods for frequency domain resource set configuration information, which can be flexibly selected according to needs during specific implementation, thereby improving diversity and flexibility of solutions.

The base station in the embodiments of the present disclosure may also be referred to as a base station equipment, and is a device deployed in a Radio Access Network (RAN) to provide radio communication functions. For example, an equipment that provides a base station function in a 2G network includes a Base Transceiver Station (BTS). An equipment that provides the base station function in a 3G network includes a Node B. An equipment that provides the base station function in a 4G network includes an evolved node B (eNB). In a Wireless Local Area Network (WLAN), an equipment that provides the base station function is an Access Point (AP). An equipment that provides the base station function in a 5G New Radio (NR) includes gNB and a continuously evolved Node B (ng-eNB), where gNB and the terminal use NR technology for communication, ng-eNB and the terminal use Evolved Universal Terrestrial Radio Access (E-UTRA) technology for communication, and both gNB and ng-eNB can be connected to a 5G core network. And the base station also refers to an equipment that provides the base station function in a new communication system in the future.

The terminal in the embodiments of the present disclosure may refer to various forms of UE, access terminal, user unit, user station, Mobile Station (MS), remote station, remote terminal, mobile equipment, user terminal, terminal equipment, wireless communication equipment, user agent or user device. The terminal equipment may further be a cellular phone, a cordless phone, a Session Initiation Protocol (SIP) phone, a Wireless Local Loop (WLL) station, a Personal Digital Assistant (PDA), a handheld device with a wireless communication function, a computing device or other processing devices connected to a wireless modems, an in-vehicle device, a wearable device, a terminal equipment in the future 5G network, or a terminal equipment in a future evolved Public Land Mobile Network (PLMN), which is not limited in the embodiments of the present disclosure.

In some embodiments, the above apparatuses may correspond to a chip in a network device, such as a System-On-Chip (SOC), a baseband chip or a chip module.

Each module/unit of each apparatus and product described in the above embodiments may be a software module/unit or a hardware module/unit or may be a software module/unit in part, and a hardware module/unit in part.

For example, for each apparatus or product applied to or integrated in a chip, each module/unit included therein may be implemented by hardware such as circuits; or, at least some modules/units may be implemented by a software program running on a processor integrated inside the chip, and the remaining (if any) part of the modules/units may be implemented by hardware such as circuits. For each apparatus or product applied to or integrated in a chip module, each module/unit included therein may be implemented by hardware such as circuits. Different modules/units may be disposed in a same component (such as a chip or a circuit module) or in different components of the chip module. Or at least some modules/units may be implemented by a software program running on a processor integrated inside the chip module, and the remaining (if any) part of the modules/units may be implemented by hardware such as circuits. For each apparatus or product applied to or integrated in a terminal, each module/unit included therein may be implemented by hardware such as circuits. Different modules/units may be disposed in a same component (such as a chip or a circuit module) or in different components of the terminal. Or at least some modules/units may be implemented by a software program running on a processor integrated inside the terminal, and the remaining (if any) part of the modules/units may be implemented by hardware such as circuits.

In an embodiment of the present disclosure, a non-volatile or non-transitory computer-readable storage medium having computer instructions stored therein is provided, where when the computer instructions are executed by a processor, the above method provided in any one of the embodiments illustrated in FIG. 2 to FIG. 6 is performed.

In an embodiment of the present disclosure, a frequency domain resource configuration apparatus including a memory and a processor is provided, where the memory has computer instructions stored therein, and when the processor executes the computer instructions, the above method provided in the embodiment illustrated in FIG. 2 is performed.

In an embodiment of the present disclosure, a frequency domain resource switching apparatus including a memory and a processor is provided, where the memory has computer instructions stored therein, and when the processor executes the computer instructions, the above method provided in the embodiment illustrated in FIG. 3 is performed.

In the above embodiments of the present disclosure, it should be understood that the disclosed method, device and system may be implemented in other ways. For example, the above device embodiments are merely illustrative, and for example, division of units is merely one logical division, and other divisions may be realized in practice, for example, a plurality of units or components may be combined or integrated into another system, or some features may be omitted, or not executed. Further, the shown or discussed mutual coupling or direct coupling or communication connection may be an indirect coupling or communication connection via some interfaces, devices or units, and may be in an electrical, mechanical or other form.

The units described as separate parts may or may not be physically separate, and parts shown as units may or may not be physical units, that is, may be disposed in one place, or may be distributed on a plurality of network units. Some or all of the units can be selected according to practical requirements to achieve the purpose of the solutions of the embodiments.

In addition, functional units in the embodiments of the present disclosure may be integrated in one processing unit, or each unit may be physically separate, or two or more units may be integrated in one unit. The integrated units can be realized in a form of hardware, or in a form of hardware plus a software functional unit.

Although the present disclosure has been disclosed above with reference to preferred embodiments thereof, it should be understood that the disclosure is presented by way of example only, and not limitation. Those skilled in the art can modify and vary the embodiments without departing from the spirit and scope of the present disclosure.

1-7. (canceled)

8. A frequency domain resource switching method, comprising:
receiving frequency domain resource set configuration information, wherein the frequency domain resource set configuration information comprises a first frequency domain resource;
determining a channel bandwidth where the first frequency domain resource is located based on the frequency domain resource set configuration information; and
switching to the first frequency domain resource and the channel bandwidth where the first frequency domain resource is located.

9. The method according to claim 8, wherein the frequency domain resource set configuration information comprises one or more first frequency domain resources and channel bandwidth information of each of the one or more first frequency domain resources, and the channel bandwidth information comprises a center frequency point and a bandwidth.

10. The method according to claim 8, wherein the frequency domain resource set configuration information comprises frequency domain resource configuration information and channel bandwidth configuration information;
the frequency domain resource configuration information comprises one or more first frequency domain resources and an index of the channel bandwidth where each of the one or more first frequency domain resources is located; and
the channel bandwidth configuration information comprises at least two channel bandwidths, and an index and channel bandwidth information of each of the at least two channel bandwidths, wherein the channel bandwidth information comprises a center frequency point and a bandwidth.

11. The method according to claim 10, wherein said determining the channel bandwidth where the first frequency domain resource is located based on the frequency domain resource set configuration information comprises:
determining the index of the channel bandwidth where the first frequency domain resource is located based on the frequency domain resource configuration information; and
determining the channel bandwidth corresponding to the index based on the channel bandwidth configuration information.

12. The method according to claim 8, wherein the frequency domain resource set configuration information comprises frequency domain resource configuration information and channel bandwidth configuration information;
the frequency domain resource configuration information comprises one or more first frequency domain resources; and
the channel bandwidth configuration information comprises at least two channel bandwidths, and channel bandwidth information of each of the at least two channel bandwidths, wherein the channel bandwidth information comprises a center frequency point and a bandwidth.

13. The method according to claim 12, wherein said determining the channel bandwidth where the first frequency domain resource is located based on the frequency domain resource set configuration information comprises:
determining channel bandwidths comprising the first frequency domain resource based on the channel bandwidth configuration information, and selecting a smallest channel bandwidth among the channel bandwidths as the channel bandwidth where the first frequency domain resource is located.

14-23. (canceled)

24. A terminal device comprising a memory and a processor, wherein the memory stores one or more programs, the one or more programs comprising computer instructions, which, when executed by the processor, cause the processor to:
receive frequency domain resource set configuration information, wherein the frequency domain resource set configuration information comprises a first frequency domain resource;
determine a channel bandwidth where the first frequency domain resource is located based on the frequency domain resource set configuration information; and
switch to the first frequency domain resource and the channel bandwidth where the first frequency domain resource is located.

25. A non-transitory computer-readable storage medium storing one or more programs, the one or more programs comprising computer instructions, which, when executed by a processor, cause the processor to:
receive frequency domain resource set configuration information, wherein the frequency domain resource set configuration information comprises a first frequency domain resource;
determine a channel bandwidth where the first frequency domain resource is located based on the frequency domain resource set configuration information; and
switch to the first frequency domain resource and the channel bandwidth where the first frequency domain resource is located.

26. (canceled)

27. The terminal device according to claim 24, wherein the frequency domain resource set configuration information comprises one or more first frequency domain resources and channel bandwidth information of each of the one or more first frequency domain resources, and the channel bandwidth information comprises a center frequency point and a bandwidth.

28. The terminal device according to claim 24, wherein the frequency domain resource set configuration information comprises frequency domain resource configuration information and channel bandwidth configuration information;
the frequency domain resource configuration information comprises one or more first frequency domain resources and an index of the channel bandwidth where each of the one or more first frequency domain resources is located; and
the channel bandwidth configuration information comprises at least two channel bandwidths, and an index and channel bandwidth information of each of the at least two channel bandwidths, wherein the channel bandwidth information comprises a center frequency point and a bandwidth.

29. The terminal device according to claim 28, wherein the processor is further caused to:
determine the index of the channel bandwidth where the first frequency domain resource is located based on the frequency domain resource configuration information; and
determine the channel bandwidth corresponding to the index based on the channel bandwidth configuration information.

30. The terminal device according to claim 24, wherein the frequency domain resource set configuration information comprises frequency domain resource configuration information and channel bandwidth configuration information;
the frequency domain resource configuration information comprises one or more first frequency domain resources; and
the channel bandwidth configuration information comprises at least two channel bandwidths, and channel bandwidth information of each of the at least two channel bandwidths, wherein the channel bandwidth information comprises a center frequency point and a bandwidth.

31. The terminal device according to claim 30, wherein the processor is further caused to:
determine channel bandwidths comprising the first frequency domain resource based on the channel bandwidth configuration information and select a smallest channel bandwidth among the channel bandwidths as the channel bandwidth where the first frequency domain resource is located.

32. The non-transitory computer-readable storage medium according to claim 25, wherein the frequency domain resource set configuration information comprises one or more first frequency domain resources and channel bandwidth information of each of the one or more first frequency domain resources, and the channel bandwidth information comprises a center frequency point and a bandwidth.

33. The non-transitory computer-readable storage medium according to claim 25, wherein the frequency domain resource set configuration information comprises frequency domain resource configuration information and channel bandwidth configuration information;
the frequency domain resource configuration information comprises one or more first frequency domain resources and an index of the channel bandwidth where each of the one or more first frequency domain resources is located; and
the channel bandwidth configuration information comprises at least two channel bandwidths, and an index and channel bandwidth information of each of the at least two channel bandwidths, wherein the channel bandwidth information comprises a center frequency point and a bandwidth.

34. The non-transitory computer-readable storage medium according to claim 33, wherein the processor is further caused to:
determine the index of the channel bandwidth where the first frequency domain resource is located based on the frequency domain resource configuration information; and
determine the channel bandwidth corresponding to the index based on the channel bandwidth configuration information.

35. The non-transitory computer-readable storage medium according to claim 25, wherein the frequency domain resource set configuration information comprises frequency domain resource configuration information and channel bandwidth configuration information;
the frequency domain resource configuration information comprises one or more first frequency domain resources; and
the channel bandwidth configuration information comprises at least two channel bandwidths, and channel bandwidth information of each of the at least two channel bandwidths, wherein the channel bandwidth information comprises a center frequency point and a bandwidth.

36. The non-transitory computer-readable storage medium according to claim 35, wherein the processor is further caused to:
determine channel bandwidths comprising the first frequency domain resource based on the channel bandwidth configuration information and select a smallest channel bandwidth among the channel bandwidths as the channel bandwidth where the first frequency domain resource is located.
